(19) United States
(12) Patent Application Publication
(10) Pub. No.: US 2003/0126073 A1
(43) Pub. Date: Jul. 3, 2003

(54) Charitable transaction risk management clearinghouse

(76) Inventor: David Lawrence, New York, NY (US)

Correspondence Address: CLIFFORD CHANCE US LLP, 200 PARK AVENUE, NEW YORK, NY, 10166, US

(21) Appl. No.: 10/313,202

(22) Filed: Dec. 6, 2002

Related U.S. Application Data
(63) Continuation-in-part of application No. 09/812,627, filed on Mar. 20, 2001.
(63) Continuation-in-part of application No. 10/021,124, filed on Oct. 30, 2001.
(63) Continuation-in-part of application No. 10/074,584, filed on Feb. 12, 2002.
(60) Provisional application No. 60/337,093, filed on Dec. 6, 2001.

(51) Int. Cl. G06F 17/60

(52) U.S. Cl. 705/38

(57) ABSTRACT

A computerized risk management method and system for facilitating analysis and quantification of risk associated with a Charitable Transaction. An automated risk management clearinghouse (CTRMC) system maintains a database relating risk variables including world events government advisories, and other information sources with potential risk for a Financial Institution. The CTRMC system can be accessed directly or tied into front end or backend systems to automatically monitor transactions. A rating system is used to assess risk based upon criteria such as risk advisories, historical data, interpretation of world events or other variables that can effect risk.

### CROSS REFERENCE TO RELATED APPLICATIONS

This application claims priority to U.S. patent application No. 60/337,093 filed Dec. 6, 2001 and entitled “Enhanced Risk Management Clearinghouse”. This application is also a continuation-in-part of a prior application entitled “Automated Global Risk Management” filed Mar. 20, 2001, bearing the Ser. No. 09/812,627, and also a continuation-in-part the prior application entitled “Risk Management Clearinghouse” filed Oct. 30, 2001, bearing the Ser. No. 10/021,124, and a continuation-in-part of the prior application entitled “Risk Management Clearinghouse” filed Feb. 12, 2002, bearing the Ser. No. 10/074,584, the contents of each are relied upon and incorporated by reference.

### BACKGROUND

This invention relates generally to a method and system for facilitating the identification, investigation, assessment, and management of legal, regulatory financial and reputational risks (“Risks”). In particular, the present invention relates to a computerized system and method to access information compiled on a worldwide basis and relate such information to a charitable transaction involving a charitable organization, wherein the information is conducive to quantifying and managing financial, legal, regulatory and reputational risk associated with the donation.

Bank and non-bank financial institutions, including: investment banks; merchant banks; commercial banks; securities firms, including broker dealers securities and commodities trading firms; asset management companies, hedge funds, mutual funds, credit rating funds, securities exchanges and bourses, institutional and individual investors, law firms, accounting firms, auditing firms and other entities, hereinafter collectively referred to as “Financial Institutions,” typically have few resources available to them to assist in the identification of present or potential risks associated with business transactions. Risk can be multifaceted and far reaching. Generally, personnel do not have available a mechanism to provide real time assistance to assess a risk factor or otherwise qualitatively manage risk. In the event of problems, it is often difficult to quantify to regulatory bodies, shareholders, newspapers and other interested parties, the diligence exercised by the Financial Institution to properly identify and respond to risk factors. Absent a means to quantify good business practices and diligent efforts to contain risk, a Financial Institution may appear to be negligent in some respect.

Risk associated with maintaining an investment account can include factors associated with financial risk, legal risk, regulatory risk, and reputational risk. Financial risk includes factors indicative of monetary costs that a Financial Institution or individual may be exposed to as a result of performing a particular transaction. Monetary costs can be related to fines, forfeitures, costs to defend an adverse position, lost revenue, or other related potential sources of expense. Regulatory risk includes factors that may cause the Financial Institution to be in violation of rules put forth by a regulatory agency such as the Securities and Exchange Commission (SEC). Reputational risk relates to harm that a Financial Institution may suffer regarding its professional standing in the industry. A Financial Institution or individual can suffer from being associated with a situation that may be interpreted as contrary to an image of honesty and forthrightness.

Risk associated with a charitable organization, and in particular, with a charitable contribution can be greatly increased due to the difficulty in gathering and accessing pertinent data on a basis timely to managing risk associated with the donation. As part of due diligence associated with a charitable organization, it is imperative for an individual, corporation, or other donor, as well as a Financial Institution involved with a transaction related to a charitable organization, to “know their customer” including whether a customer is contained on a list of restricted entities published by the Office of Foreign Access Control (OFAC), the Treasury Office or other government or industry organization.

However, Financial Institutions do not have available a mechanism which can provide real time assistance to assess a risk factor associated with charitable organizations, or otherwise qualitatively manage such risk. In the event of problems arising from a transaction that involves a charitable organization, it is often difficult to quantify to regulatory bodies, shareholders, newspapers and/or other interested parties, the diligence exercised by the parties involved to properly identify and respond to risk factors. Absent a means to quantify good business practices and diligent efforts to contain risk, a donor or a Financial Institution may appear to be negligent in some respect.

What is needed is a method and system to draw upon information gathered globally and utilize the information to assist with risk management and due diligence related to charitable organizations. A new method and system should anticipate offering guidance to personnel who interact with donors and help the personnel identify high risk situations. In addition, it should be situated to convey risk information to a compliance department and be able to demonstrate to regulators that a donating entity or a Financial Institution involved has met standards relating to risk containment.

### SUMMARY

Accordingly, the present invention provides a risk management method and system for facilitating analysis and quantification of risk associated with a Charitable Transaction. An automated charitable transaction risk management clearinghouse (CTRMC) system maintains a database relating risk variables including world events, government advisories, and other information sources with potential risk for a Financial Institution. The CTRMC system can be accessed directly or tied into front end or backend systems to automatically monitor transactions. In some embodiments, a rating system can be used to assess risk based upon criteria such as risk advisories, historical data, interpretation of world events or other variables that can effect risk.

Information generated by a CTRMC system can be utilized to generate a risk quotient or other rating based upon a weighted algorithm applied to the criteria, wherein the risk quotient is indicative of risk associated with a transaction or an account. The quotient can be monitored on a periodic basis, during the course of a transaction, upon account opening or on demand. Actions commensurate with a risk quotient can be presented to a Financial Institution to help the institution properly manage risk associated with a particular entity or transaction.

A log or other stored history can be created such that utilization of the system can mitigate adverse effects relating to a problematic transaction. Mitigation can be accomplished by demonstrating to regulatory bodies, shareholders, news media, and other interested parties that corporate governance is being addressed through tangible risk management processes.

In another aspect, a computer system for providing risk management relating to a Charitable Transaction can include a computer server that is accessible with a network access device, computer system via a communications network or direct link, and executable software stored on the server which is executable on demand. The software can be operative with the server to gather or receive information relating to risk factors and formulate a risk quotient or other rating. In addition, where applicable, risk can be aggregated, such as by rating, and transferred.

The present invention includes a computer-implemented method for managing risk, which can be related to a Charitable Transaction involving domestic, international or global exposure. The method includes receiving information relating to specific details of a Charitable Transaction and structuring the information received according to risk quotient criteria. A risk quotient is calculated using the structured information. A suggested action responsive to the risk quotient or the information received can also be generated.

Typically a suggested action will be directed towards reducing risk relating to a Charitable Transaction, although actions can be directed towards anti terrorist activities, law enforcement or other directives. In some embodiments, an action can include refusing to perform a Charitable Transaction or notifying an authority, such as a law enforcement agency.

In another aspect, the information received, including specific documentation, can be stored, as can a suggested action, and utilized to generate a diligence report. The diligence report can include information relating to a Charitable Transaction and one or more actions taken responsive to a risk quotient generated.

Still another aspect can include aggregating risk quotients relating to a particular charity, donor, or Financial Institution involved to assess a level of identified risk. An average risk quotient associated with a transaction can also be calculated.

Other embodiments include a computerized system for managing risk associated with a Charitable Transaction, computer executable program code residing on a computer-readable medium, a computer data signal embodied in a digital data stream, or a method of interacting with a network access device. Accordingly, various features and embodiments are further described in the following figures, drawings, and claims.

### DESCRIPTION OF THE DRAWINGS

FIG. 1A illustrates a block diagram of elements of some embodiments of the present invention.

FIG. 1B illustrates a block diagram with exemplary descriptions of elements of some embodiments of the present invention.

FIG. 2A illustrates a flow of exemplary steps that can be executed while practicing the present invention.

FIG. 2B illustrates a flow of additional exemplary steps that can be executed while practicing the present invention.

FIG. 3A illustrates a flow of exemplary steps related to risk quotients and a suggested action.

FIG. 3B illustrates steps that can be performed from the perspective of a user while practicing some embodiments of the present invention.

FIG. 4 illustrates a network of computer systems that can be included in some embodiments of the present invention.

FIG. 5 illustrates a computerized device that can be utilized to implement some embodiments of the present invention.

FIG. 6 illustrates an exemplary graphical user interface that can implement various aspects of the present invention.

FIG. 7 illustrates an exemplary data structure that can be utilized to implement certain aspects of the present invention.

### DETAILED DESCRIPTION

The present invention includes a computerized methods and systems for managing risk associated with a Charitable Transaction. A computerized system gathers and stores information in a database or other data storing structure and relates the information to risk factors pertaining to the Charitable Transaction. In some embodiments, documents and sources of information can also be stored. A subscriber, such as an individual donor, government agency, corporate donor, Financial Institution, or other interested party, can access the database to assess risk associated with a Charitable Transaction. Some embodiments can also include access to the database via an automated query that is made part of standard operating procedure for each Charitable Transaction processed by the subscriber.

A transfer of funds to or from the charitable organization may involve a donation or a grant that is manifested with a cheque, draft, credit card transaction, wire transfer, equity transfer or other currency transaction hereinafter collectively referred to as a “Charitable Transaction.”

A subscriber can include any entity, donor, recipient, individual, corporation, company, limited liability company (LLC), or other definable person who has access to a CTRMC system.

A decision by a party concerning whether to pursue a Charitable Transaction can be dependent upon many factors. A multitude and diversity of risks related to the factors may need to be identified and evaluated. In addition, the weight and commercial or reputational implications of the factors and associated risks can be interrelated. The present invention can provide a consistent and uniform method for business, legal, compliance, public relations and others to identify and assess risks associated with a Charitable Transaction.

Embodiments can include generation of a rating that can be used to assess risk associated with a Charitable Transaction. The rating, such as a risk quotient, can be used to readily indicate a level of risk associated with a particular Charitable Transaction or entity involved. The risk quotient can be based upon and supported by gathered data. A risk quotient can be based upon a weighted algorithm applied to data descriptive of risk factors. Examples of risk factors can include, for example, a high risk designation from a government agency, how funds from a charitable organization are dispersed and to whom, public documentation, a commissioned report, or other source. The risk quotient can be made available on a periodic basis, on demand in real time, in response to an event such as a transaction, or according to some other request. Actions commensurate with identified Risk can be presented to assist with proper risk management.

Elements

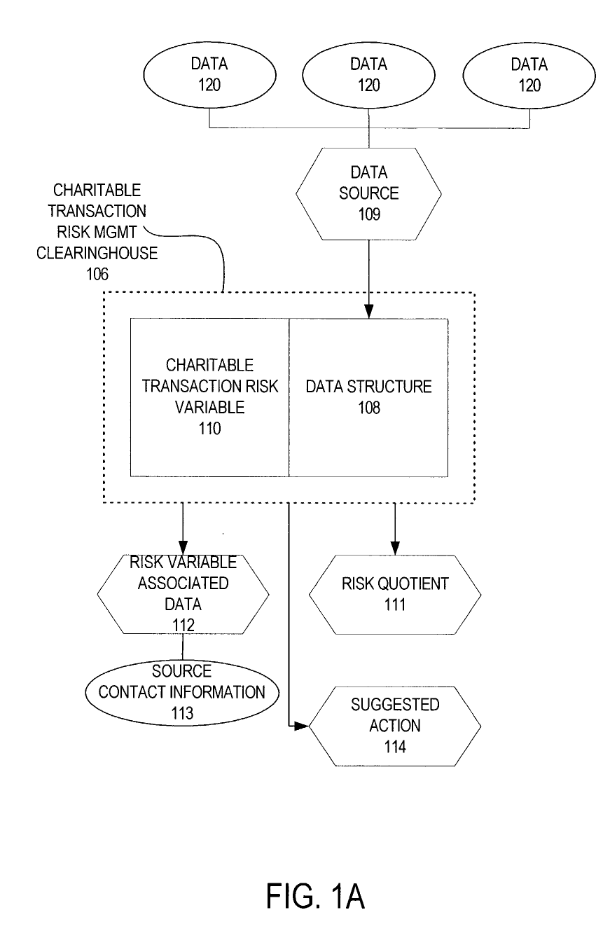

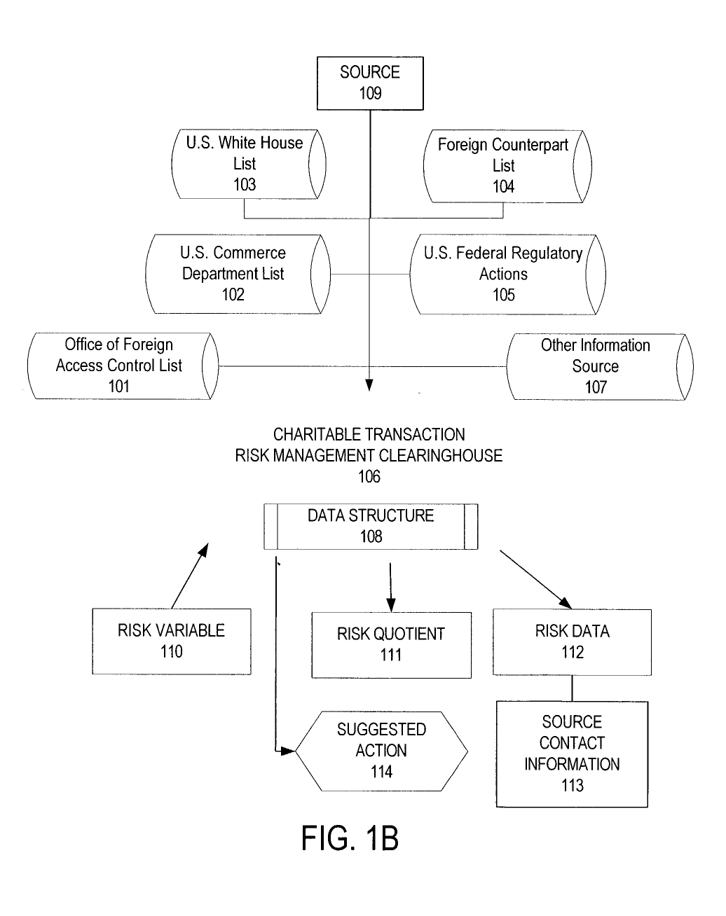

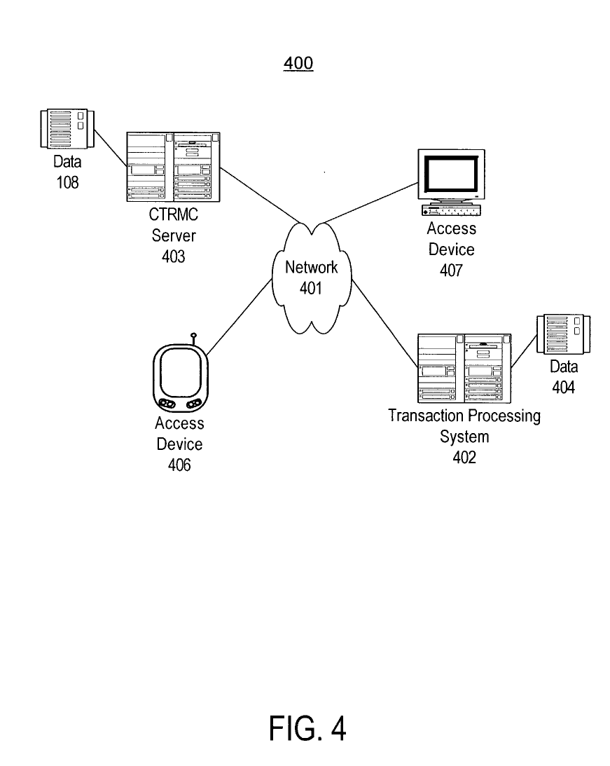

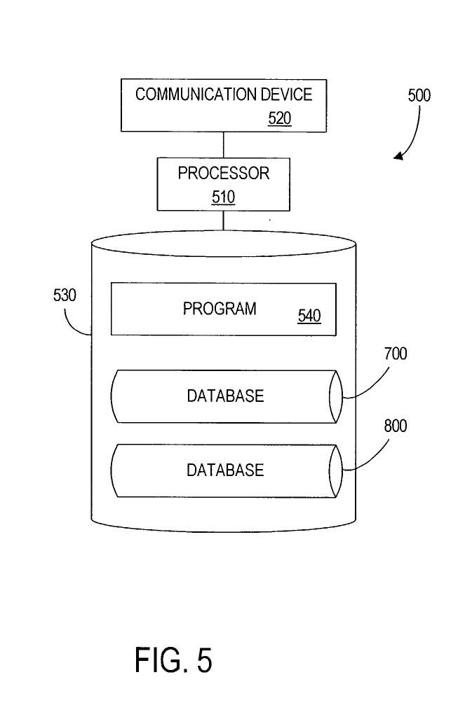

Referring now to FIG. 1A, a block diagram including elements of some embodiments of the present invention is illustrated. A Risk Management Clearinghouse(CTRMC) system 106, receives informational data 120 from a data source 109. The CTRMC System 106 can include a computerized system programmed or otherwise functioning to perform the various inventive functions described herein. A detailed description of some embodiments of a CTRMC System 106 are disclosed herein with particular implementation discussed in relation to FIGS. 4 and 5.

A data source 109 can include, for example, a publicly available source, a subscriber, an investigative entity, private contributor, publications issued by Treasury's Financial Crimes Enforcement Network (“FinCEN”), the State Department, the CIA, the General Accounting Office, Congress, the Financial Action Task Force (“FATF”), various international Financial Institutions (such as the World Bank and the International Monetary Fund), the United Nations, other government and non-government organizations, internet websites, news feeds, commercial databases, or other source.

Data can be varied according to a source and generally include any humanly discernable information. It can also include artifacts, such as, for example, copy of a government report, a news article, a document, a transcript, a cite, a court record, or other article. Specific examples of data sources are illustrated in FIG. 1B. Embodiments can include data 120 that is periodically updated, constantly updated in real time, or updated in response to a request.

Received data 120 can be stored in a data structure 108 that relates the data 120 to one or more charitable transaction risk variables 102. For the purposes of this specification, a risk variable can include any piece of information that relates to a charitable transaction and may affect an amount of risk associated with the charitable transaction. For example, a risk variable 110 may include: a status of whether an organization qualifies as registered charity with a government; relevant financial information; principals associated with an organization; employees of an organization, board member of a charitable organization; a percentage of funds actually utilized for a charitable purpose; recipients of monies or services from the organization, other beneficiaries of an organization's activities, a stated purpose of the organization, the domicile of the organization, any affiliations the organization may have, wire transfer receipt/payment parties or other variable.

The CTRMC System 106 can determine which data 120 included in the data structure 108 is associated with the one or more Charitable Transaction risk variables and output the risk variable associated data 110. The data 120 can be associated with a risk variable or other subject with programmed data association techniques, such as, for example, keyword search, fuzzy logic, artificial intelligence programs, full text, numerical value, financial value, coded entry or other well known or proprietary forms of data manipulation.

Output can include a graphical user interface, hardcopy, facsimile, e-mail, messaging or other communication with any humanly or machine discernable data and/or artifacts. In some embodiments, output can include transmitting the risk variable related data 104 to a designated recipient. any humanly or machine discernable data and/or artifacts.

The CTRMC System 106 can also output a risk quotient 111, or other measurement, that quantifies an amount of risk that is associated with a particular Charitable Transaction or risk variable 102.

A suggested action can be generated by the CTRMC System 106 based upon the risk quotient 111 and the risk data 112. The suggested action 114 can help a user determine an appropriate response to a given set of circumstances. In addition, a suggested action can mitigate risk by allowing a user to demonstrate adherence to a quantifiable set of procedures aimed to meet practice norms. Some embodiments can also allow a CTRMC system 106 to automatically respond to certain risk quotient 111 values. For example, if a transaction reaches or exceeds a risk quotient threshold, the CTRMC system 106 can respond with a predetermined action such as, generating an alert, blocking acceptance of a transaction, creating a report, notifying a compliance department, or other appropriate response.

Referring now to FIG. 1B, a block diagram illustrates exemplary data 210, such as public information received from a variety of information sources, that may be utilized in some embodiments to provide risk related data to a CTRMC System 106. Specifically, in some embodiments, data 120 that can relate to a risk variable 110 can include: a list generated by the Office of Foreign Assets Control (OFAC) 101, including their sanction and embargo list, a list generated by the U.S. Commerce Department 102, a list of international “kingpins” generated by the U.S. White House 103, a list generated by a foreign counterpart to a U.S. entity 104, U.S. regulatory actions 105 or other information source 107 such as a foreign government, US adverse business-related media reports, US state regulatory enforcement actions, international regulatory enforcement actions, international adverse business-related media reports, a list of terrorist organizations, a list of politically connected individuals and military leaders, a list of U.S. and international organized crime members and affiliates, or a list of recognized high risk countries. Court records or other references relating to fraud, bankruptcy, professional reprimands or a rescission of a right to practice, suspension from professional ranks, disbarment, prison records or other sources of suspect behavior can also be included, as can public documents and publications such as newspapers, periodicals, news feeds, internet postings, government filings or other source of public information. Information sources can include various foreign equivalents to those listed above or any other international source.

Accordingly, information supplied by an information source 109 may be information gathered from public sources, through a normal course of dealings with a particular charitable organization or other entity, or through a concerted investigation related to a charitable organization. Information received from an information source also may be subject to applicable law including privacy laws, wherein safeguards can be put in place to prevent such information from being made available to other entities. In addition, a Financial Institution, or other subscriber may discover or suspect that a person or entity is involved in some fraudulent or otherwise illegal activity and report this information to the CTRMC system 106 and/or an appropriate authority.

A subscriber or other entity that may provide a risk variable 110 to a CTRMC to facilitate managing risk associated with a Charitable Transaction may include, for example: a corporate or private donor, a political figure, a charitable organization, an investigative reporter, a watchdog organization, a securities broker, retail bank, commercial bank, investment and merchant bank, private equity firm, asset management company, mutual fund company, hedge fund firm, insurance company, credit card issuer, retail and commercial financier, securities exchange, other regulator, money transfer agency, or other entity.

Donors or other participants to a Charitable Transaction, including corporate donors and Financial Institutions, may be regulated. As a result, such donors can be exposed to significant risks from an obligation to comply with the law and to prevent, detect, and, at times, report potential violations of laws, regulations and industry rules (“laws”). These risks include, but are not limited to, the duty to disclose material information, and to prevent, and possibly report: fraud, money laundering, foreign corrupt practices, bribery, embargoes and sanctions.

As part of a conducting a Charitable Transaction, a series of structured questions can be presented to a participant. Information received as answers can be utilized to determine risk variables used in a risk management query. Results of the query can be combined with the answers to be weighted and analyzed via risk algorithms. The results of the analysis can generate a risk quotient to structure a risk exposure. The risk quotient can include, for example, a scaled numeric or alpha-numeric value.

Some embodiments can include a CTRMC system 106 integrated as part of legal and regulatory oversight for various due diligence and “know your customer” obligations imposed by regulatory authorities. The CTRMC system 106 can facilitate detection and reporting of potential violations of law as well as address the “suitability” of a Charitable Transaction and/or the assessment of sophistication of a customer. Similarly, the CTRMC system 106 can support a party involved in a Charitable Contribution in an effort to meet requirements regarding the maintenance of accurate books and records relating to their Charitable Transactions and affirmative duty to disclose material issues affecting an party's decisions.

A log or other stored history can be created such that utilization of the system can mitigate adverse effects relating to a problematic Charitable Transaction. Mitigation can be accomplished by demonstrating to government agencies, donors, charity recipients, regulatory bodies, shareholders, news media and other interested parties that corporate governance is being addressed through tangible risk management processes which include continual gathering of risk related information and application of the risk related information to Charitable Transaction to assess a level of risk.

In some embodiments, the CTRMC system 106 can also receive an open query, which may or may not necessarily be associated with a particular Charitable Transaction. For example, a user may wish to conduct research relating to any charity that provides relief services to a certain geographic area, information on a particular philanthropist, who is a donor to a particular charity, what charities a particular person donates to, whether any charitable organizations address a particular purpose, or other subject.

Some embodiments can include one or more risk variables that are automatically generated as a result of monitoring transactions being conducted by a computerized system utilized for processing Charitable Transactions. For example, an information system involved in a Charitable Transaction can be electronically scanned for key words, entity names, geographic locales, or other pertinent data. A query can be formulated based upon one or more risk variables 110 ascertained as a result of the electronic scan. The query can be and run against the data structure 108 maintained in the CTRMC system 106.

Still other embodiments can include a voice query via a telephone or other voice line, such as voice over internet, fax, electronic messaging, or other means of communication, a query input into a GUI, or other means.

If appropriate, some embodiments can include an alert list containing one or more risk variables, such as a name and/or a term of interest to a user. In some embodiments, an alert list can include a standardized set of terms, or be customized and specific to a specific user. The CTRMC system 106 can continually monitor data in its database via an alert query with key word, fuzzy logic or other search algorithms and transmit related informational data, associated risk quotients, suggested actions or other output to the interested party. In this manner, ongoing diligence can be conducted. In the event that new information is uncovered by the alert query, the subscriber can be immediately notified, or notified according to a predetermined schedule. Appropriate action can be taken according to the information uncovered.

A typical use of a query to a CTRMC system 106 is to investigate a charitable organization prior to making a donation to it. For example, before making a contribution, a donor, such as a corporation may want to ascertain that a charity qualifies as a registered charity and that no warnings have been published by a government agency concerning the charity. The corporation may also be interested in the efficiency of the charity and request a percentage of the amount of contributions that are spent on the targeted charitable purpose.

An ongoing monitoring can also be put in place whereby the CTRMC system 106 can continuously or periodically research a charity or list of charities and generate an indication of any changes in the status of the charity and any accompanying artifacts.

In another aspect, in some embodiments, a Financial Institution, such as, for example, a credit card issuer or bank, may monitor transactions they are asked to execute or otherwise participate in. The monitoring would allow the Financial Institution to ascertain if any of the transactions involves a charitable organization contained on a list generated by a government agency or other authority. For example, a credit card issuer may monitor transactions to ascertain if any payments have been made to a charity that the government has linked to terrorist activity. Similarly, wire transfers or other payments can also be monitored. Principals associated with a charitable organization can also be the subject of such monitoring.

In still another aspect, in some embodiments, an aggregate risk quotient score can be generated to assess a level of risk being tolerated by an institution. Other calculations, such as, for example, the sum, mean, average, or other calculation can also be made to further analyze risk at an institution. If desired, a rating can be applied to an institution according to the amount of risk tolerated by the institution, such as, for example, the average risk tolerated.

Methods

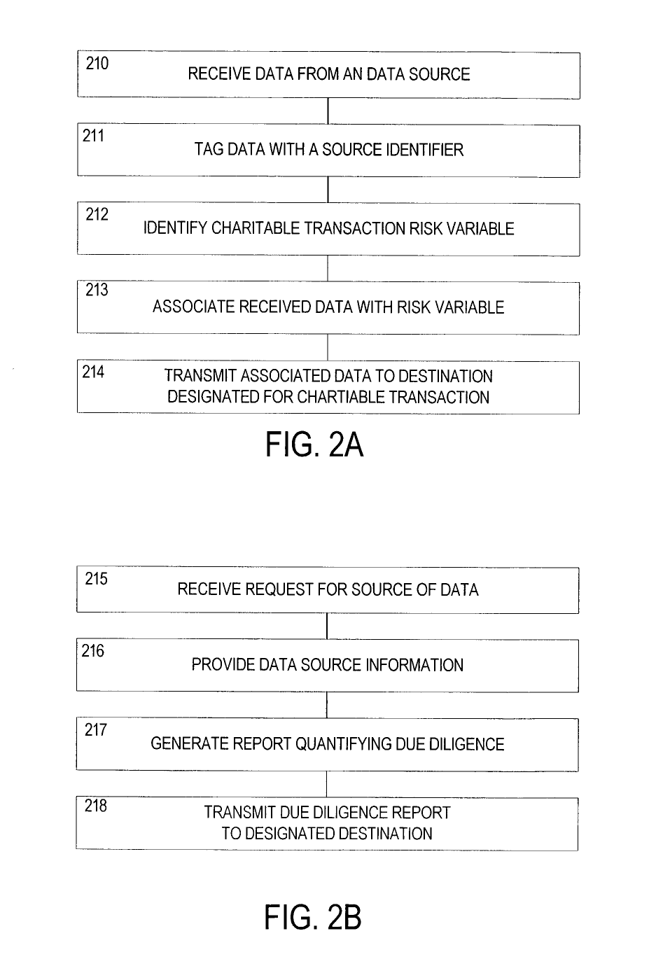

Referring now to FIG. 2A, steps are illustrated which can be utilized to manage risk associated with a Charitable Transaction according to the present invention. At 210, a CTRMC System 106 can receive informational data 120 from a data source. Informational data 120 can be gathered from a subscriber or a source of electronic data such as an investigation firm, external database, messaging system, news feed, government agency, or other data provider. Information can be received on an ongoing basis such that if new events occur in the world which affect the risk exposure of a transactor, an estimated risk value can be adjusted accordingly.

In addition to the types and sources of data 120 listed previously that can relevant to an associated amount of risk, other data that can be indicative of risk can include: a request to involve a Financial Institution that is not accustomed to a particular type of transaction, such as foreign account activity; to perform the unaccustomed transaction; a request for secrecy or an exception to Bank Secrecy Act requirements; routing through a secrecy jurisdiction; missing wire transfer information; unusual and unexplained fund or transaction activity, such as fund flow through several jurisdictions or Financial Institutions; use of a government-owned bank; excessive funds or wire transfers; rapid increase or decrease of funds, or asset value, associated with a charitable organization which is not attributable to the market value of investments; high value deposits or withdrawals; wires of the same amount of funds into and out of a charitable organization; frequent zeroing of a charitable organizations account balance; large currency or bearer transactions associated with a charitable organization, or structuring of one or more transactions below reporting thresholds.

At 211, the CTRMC System 106 can tag data received with a source identifier. The source identifier can include additional datum that is indicative of a person, place or entity that provided information to the CTRMC System 106. In some embodiments, a profile can be maintained containing data descriptive of each source, including contact information, such as contact name, address, telephone number, e-mail address, instant messenger address, or any other indication of how to communicate with a particular source.

At 212, charitable transaction risk variables can be identified. For example, it can be determined that the status of whether an organization qualifies as registered charity with a government is a risk variable for a Charitable Transaction. Other examples of risk variables can include: relevant financial information; principals associated with an organization; employees of an organization; a percentage of funds actually utilized for a charitable purpose; recipients of monies or services from the organization; other beneficiaries of an organization's activities; a stated purpose of the organization; the domicile of the organization; any affiliations the organization may have; and wire transfer receipt/payment parties.

At 213, the CTRMC System 106 can associate received data 120 with one or more risk variables 110 and at 214, the associated data can be transmitted to a designated destination.

Referring now to FIG. 2B, additional steps that can be implemented while practicing the present invention are illustrated. At 215, the CTRMC system 106 can receive a request for data descriptive of a source 109 of particular data 120. The CTRMC System 106 can provide the data descriptive of the source 109 of particular data 120 by referring to a source identifier with which the data 120 is tagged and transmitting data associated with the source identifier.

At 217, the CTRMC System 106 can generate a report quantifying due diligence efforts made in connection with a Charitable Transaction. The report can include, for example, what risk variables 110 were included in a risk management query, risk variable data associated with the data 112 as a result of the query, a risk quotient 111 generated, a suggested action 114 and data descriptive of a source of relevant data 112. At 218, the due diligence report can be transmitted to a designated destination, such as, for example, a compliance department, a donor, a legal department, a public relations person, or other destination.

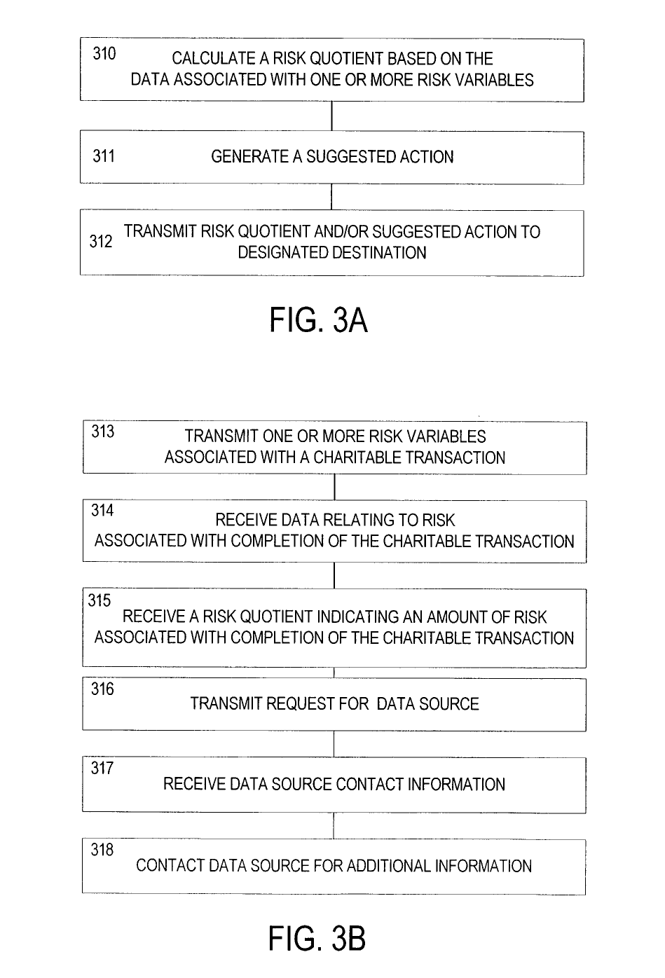

Referring now to FIG. 3A, further steps that can be implemented while implementing certain aspects of the present invention are illustrated. At 310, a risk quotient 111 can be calculated that is based upon the risk variable associated data 112. In some embodiments, a risk quotient 111 can be calculated by weighting the information received according to its importance in determining high risk activities, such as the likelihood of illegal or unethical dealings. Calculating a risk quotient can be accomplished by assigning a numerical value to risk variable associated data 112, wherein the numerical value is representative of the risk associated with the particular data. For example, it may be determined in one case that a corporate officer from a corporation domiciled in a G-7 country authorizing a donation to an international relief organization poses minimal risk. Therefore this information from the first case is assigned a low numerical value, or even a negative numerical value. In a second case, an individual who appears on a list generated by the FATF and is attempting to make a contribution to an organization with a stated mission of providing aid to a political arena known to harbor terrorists may be viewed as a high risk and assigned a high numerical value. In addition, a weight can be assigned to a CTRMC risk category to which the information is assigned. Therefore, a designated charitable entity may receive a higher weight than a particular donor, or vice versa. A Risk Quotient can be calculated by multiplying a weighted numerical value of the specific information times the category weighting.

For example, information received may indicate a donor is an unidentified national or a high risk country. A designated charity may be a small organization formed within the past 6 months in America. The donor information may receive a numerical value of 18 because it is a relatively high risk description. In addition, this information may be included in a donor profile category, wherein the donor profile is assigned a category weighting of 3. Therefore, the net score for this ownership structure is −18 times 3 or −54. Similarly the organization without an established track record may also receive a number indicating high risk, such as −15. The CTRMC risk quotient for the organization would be 15 times 3, or −45. All scores within the Company Profile can be summed to calculate a CTRMC risk quotient. A calculation can therefore include a CTRMC risk quotient equivalent to −54+−45 which equals −99, indicating a high risk. Weighted risk scores from all associated categories can be summed to calculate a total Risk Quotient 111 score.

At 311, a suggested action 114 can be generated that is based upon, or otherwise responsive to, the risk variable associated data 112, the risk quotient 111, or other factor. For example, in response to a high risk score a suggested action may be to not proceed with a related Charitable Transaction, or to notify an appropriate authority. In response to a low risk score, a suggested action 114 may indicate that a relevant transaction should be completed. An intermediate risk quotient 111 may generate a suggested action indicating that additional information should be gathered, that transactions for this account should be monitored, or other interim measure.

At 312, the risk quotient 111 and/or the suggested action 114 can be transmitted to a designated destination. For example, the transmission can include an e-mail to a designated e-mail address, or transmitting a signal over a communications network to a receiving device that is operative to display an indication of the risk quotient 111 and/or the suggested action 114, such as, for example via GUI.

Referring now to FIG. 3B, a flow chart illustrates steps that a user can implement to manage risk associated with a Charitable Transaction. At 313, the user can transmit to the CTRMC System 106 one or more risk variables associated with the transaction. The transmission can be accomplished by opening a dialogue with a CTRMC system 106. Typically, the dialogue would be opened by presenting a GUI to an access device or other computerized system. The GUI can be capable of accepting data input via a user input device. For example, a GUI can include a series of questions relating to a Charitable Transaction and user interactive portions for accepting input responsive to the questions. Alternatively, information can be received directly into fields of a database, such as from a commercial data source.

In some embodiments, automated monitoring software can run in the background of a normal transaction program and screen data traversing an application. The screened data can be processed to determine key words wherein the key words can in turn be transmitted to the CTRMC system 106 as risk variables. The CTRMC System 106 can process the key words to associate entities, jurisdictions, or other data 120 with risk variables 110. Monitoring software can also be installed to screen data traversing a network or communications link.

At 314, a user can receive risk variable associated data 112 relating to Risk that may be associated with completing a Charitable Transaction. The data 112 received can include, for example: text messages, artifacts, a copy of related news articles, documents or any other risk variable related data 112. At 315, the user can also receive a risk quotient indicating an amount of risk associated with completing a Charitable Transaction.

At 316, if a user wishes to follow up by receiving more information or additional details regarding data 112 received, the subscriber can request a link from the CTRMC system 106 to an information source 109 for particular information. For example, if the CTRMC system 106 has information in the data structure 108 indicating that a particular person may have particular traits that indicate high risk, the user may wish to obtain additional information descriptive of that person. The CTRMC system 106 may have tagged the information when it was received with an identifier of the data source 109, for example an investigation firm. The user can request contact information to the investigation firm, which is the source 109.

At 317, the user can receive the data source 109 contact information, and at 318 the user can contact the data source 109 for additional information.

Systems

Referring now to FIG. 4, a network diagram illustrating some embodiments of the present invention is shown 400. An automated CTRMC system 403 can include a computerized server accessible via a distributed network 401 such as the Internet, or a private network. An automated transaction processing system 402 can also include a computerized server accessible via the distributed network 401. A user can use a computerized system or network access device 406-407 to receive, input, transmit or view information processed in the CTRMC system 403, transaction processing system 402, a peer device, or other network access device 406-407. A protocol, such as, for example, the transmission control protocol internet protocol (TCP/IP) can be utilized to provide consistency and reliability.

A system access device 406-407 can communicate with the CTRMC system 403 or transaction processing system 402 to access data and programs stored at the respective servers. A system access device 406-407 may interact with the CTRMC system 403 or transaction processing system 402 as if the servers were a single entity in the network 400. However, the CTRMC system 403 and transaction processing system 402 may include multiple processing and database sub-systems, such as cooperative or redundant processing and/or database servers that can be geographically dispersed throughout the network 400.

A server utilized in a transaction processing system 402 and CTRMC server 403 can include a processor, memory and a user input device, such as a keyboard and/or mouse, and a user output device, such as a display screen and/or printer, as further detailed in FIG. 5. Any server can also include one or more databases 108, 404 storing data relating to an IPO, bidders, associated risks, or other pertinent information. Information relating to and included in a Charitable Transaction risk management can be aggregated into a searchable data storage structure. Gathering data into an aggregate data structure 108, 404, such as a data warehouse, allows a server 402-403 to have the data readily available for processing a risk management search associated with a company's earnings. Aggregated data 108, 404 can also be scrubbed or otherwise enhanced to aid in searching.

Typically, an access device 406-407 will access a CTRMC server 403 using client software executed at the system access device 406-407. The client software may include a generic hypertext markup language (HTML) browser, such as Netscape Navigator or Microsoft Internet Explorer, (a “WEB browser”). The client software may also be a proprietary browser, and/or other host access software. In some cases, an executable program, such as a Java™ program, may be downloaded from a server to the system access device 406-407 and executed at the system access device 406-407 as part of a CTRMC server 403. Other implementations include proprietary software installed from a computer readable medium, such as a CD ROM. The invention may therefore be implemented in digital electronic circuitry, computer hardware, firmware, software, or in combinations of the above. Apparatus of the invention may therefore be implemented in a computer program product tangibly embodied in a machine-readable storage device for execution by a programmable processor; and method steps of the invention may be performed by a programmable processor executing a program of instructions to perform functions of the invention by operating on input data and generating output.

In some embodiments, data contained in a database can be scrubbed or otherwise enhanced. Data scrubbing can be utilized to store information in a manner that gives efficient access to pertinent data and facilitate expedient access to data.

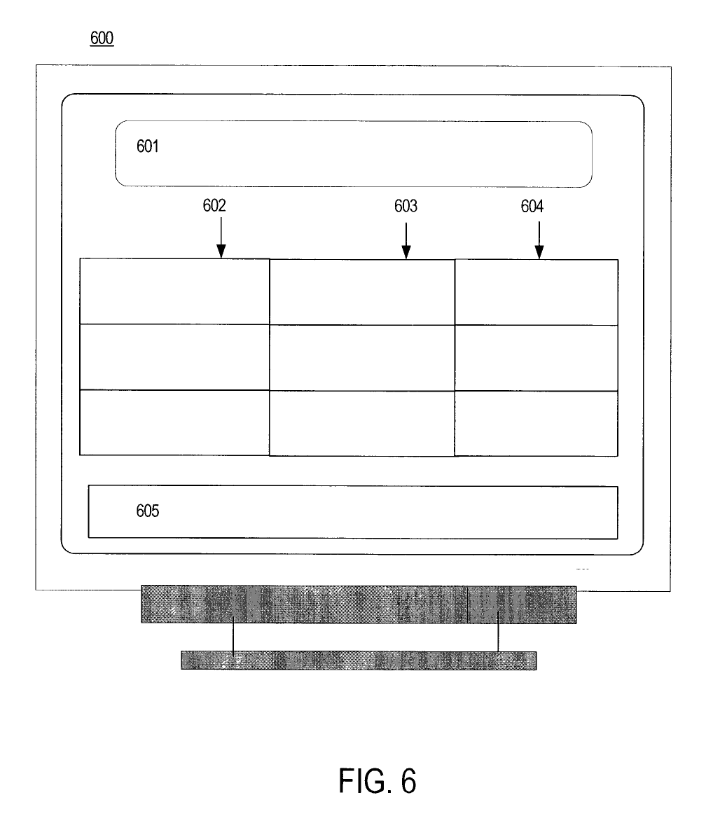

FIG. 5 illustrates a controller 500 that can be descriptive of a server 108, 404 or access device 406-407 shown, for example, in FIG. 4, according to some embodiments of the present invention. The CTRMC server 403 comprises a processor 510, such as one or more processors, coupled to a communication device 520 configured to communicate via a communication network (not shown in FIG. 6). The communication device 520 may be used to communicate, for example, with one or more network access devices 406-407.

The processor 510 is also in communication with a storage device 530. The storage device 530 may comprise any appropriate information storage device, including combinations of magnetic storage devices (e.g., magnetic tape and hard disk drives), optical storage devices, and/or semiconductor memory devices such as Random Access Memory (RAM) devices and Read Only Memory (ROM) devices.

The storage device 530 can store a program 540 for controlling the processor 510. The processor 510 performs instructions of the program 540, and thereby operates in accordance with the present invention. For example, the processor 510 may receive information descriptive of an IPO including auction and pre-auction details and allocate shares according to rules defined by the details. The processor 610 may also transmit information comprising share allocation, pricing, or other information.

The storage device 530 can store Charitable Transaction risk management related data in a database 700, and other data 800 as needed. The illustration and accompanying description of the database presented herein is exemplary, and any number of other database arrangements can be employed besides those suggested by the figures.

Graphical User Interface

Referring now to FIG. 6, an exemplary GUI 600 that can be utilized while practicing the present invention is illustrated. The GUI can be presented on a network access device 406-407 or any other type of terminal or interactive station capable of creating a display pursuant to an electronic signal. The GUI can include areas prompting for information, such as in the form of a key word or a question 601. Areas can also be included for receiving an appropriate response 602, such as an area to receive text, allow a selection from choices proffered, or otherwise interactively receive data or other input into the CTRMC server 403. A programmable user interactive device, such as a checkbox, X field, yes/no filed, programmable icon, hyperlink, push button or other device can also be utilized to indicate an answer, or otherwise input information. A category weighting area 603 can also be indicated on the GUI 600 that allows the display or modification of weighting value, such as a numerical value, that can be utilized to calculate a risk quotient. A CTRMC GUI 600 can also include an area for displaying a quotient score relating to the transaction 604.

Data Structure

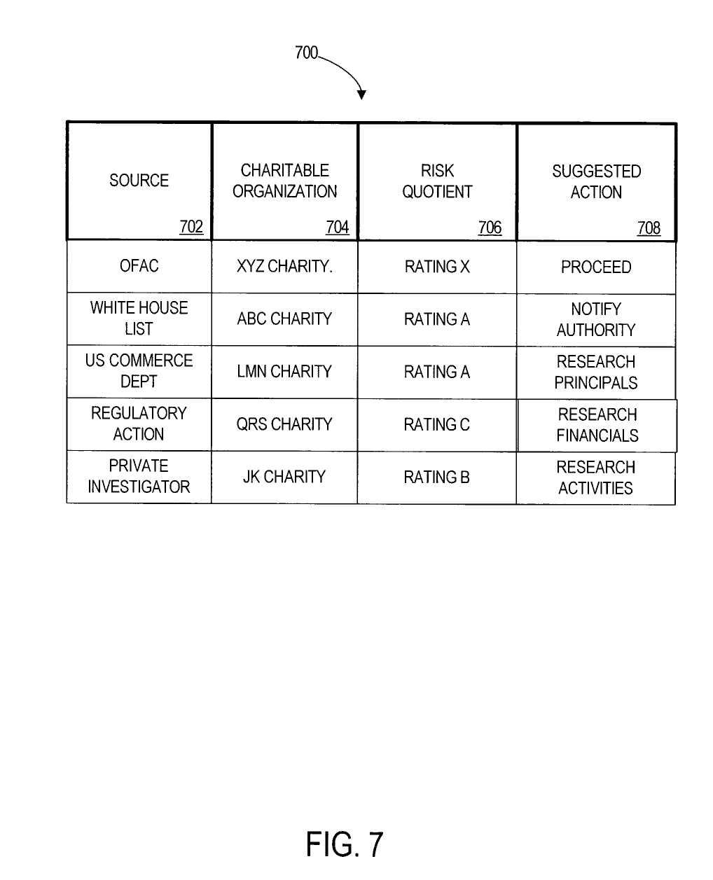

Referring now to FIG. 7, a design of a portion of database that can be utilized while implementing the present invention is illustrated. The database 700 can include a field 702 containing data descriptive of a source 109, as well as a field 704 containing data descriptive of a charitable organization. Another field 706 can hold data descriptive of a risk quotient. Still another field 708 can contain data related to a suggested action. Obviously, other data fields storing data utilized in various facets of the present invention can also be included. The data can be arranged and accessed using any known data storage and accessing techniques.

A number of embodiments of the present invention have been described. Nevertheless, it will be understood that various modifications may be made without departing from the spirit and scope of the invention. For example, a network access devices 406-407 can comprise a personal computer or a wireless handheld device executing an operating system such as Microsoft Windows™, UniX™, Linux or Apple Mac OS™, as well as software applications, such as a

JAVA program or a web browser. network access devices 406-407 can also be a terminal device, a palm-type computer, mobile WEB access device, a TV WEB browser or other device that can adhere to a point-to-point or network communication protocol such as the Internet protocol. Accordingly, other embodiments are within the scope of the following claims.

What is claimed is:

1. A computer-implemented method for managing risk related to a charitable transaction, the method comprising:
identifying one or more risk variables associated with a charitable transaction;
receiving informational data from an information source;
associating the received informational data with one or more of the risk variables; and
transmitting the associated informational data to a designated destination.

2. The computer-implemented method of claim 1 additionally comprising the step of receiving an indication of one or more risk variables from a user.

3. The method of claim 1 or 2 additionally comprising the step of generating a risk quotient and a suggested action responsive to the risk quotient.

4. The method of claim 3 additionally comprising the steps of:
storing the information received, the risk quotient and the suggested action; and
generating a diligence report referencing the stored information.

5. The method of claim 3 wherein the diligence report comprises the information received relating to details of the charitable transaction and actions taken responsive to the risk quotient.

6. The method of claim 3 wherein the suggested action is additionally responsive to the information received.

7. The method of claim 3 wherein the suggested actions are directed towards reducing risk related to a charitable transaction with international exposure.

8. The method of claim 3 wherein the suggested action comprises refusing to perform a transaction.

9. The method of claim 3 wherein the suggested action comprises notifying an authority.

10. The method of claim 3 additionally comprising the step of aggregating risk quotients relating to a financial institution to assess a level of identified risk to which the financial institution is exposed.

11. The method of claim 3 additionally comprising the step of calculating an average risk quotient associated with a transaction.

12. The method of claim 1 or 2 wherein the risk variable comprises an indication of the name of a charitable organization.

13. The method of claim 1 or 2 wherein the risk variable comprises an indication of the identity of an entity involved in the transaction.

14. The method of claim 1 or 2 wherein the risk variable comprises an indication of the identity of a board member of a charitable organization.

15. The method of claim 1 or 2 wherein the risk variable comprises an indication of the identity of an employee of a charitable organization.

16. The method of claim 1 or 2 wherein the informational data is received electronically.

17. The method of claim 1 or 2 wherein the Charitable Transaction comprises opening a financial account.

18. A computerized system for managing risk associated with a financial account, the system comprising:
a computer server accessible with a computerized device via a communications network; and
executable software stored on the server and executable on demand, the software operative with the server to cause the system to:
receive informational data from an information source;
tagging the information with an indicator of the information source;
receive one or more charitable transaction risk variables;
associate the informational data from an information source to the charitable transaction risk variables; and
transmit the informational data associated with the charitable transaction risk variables and an indication of the information source to a designated destination.

19. The computerized system of claim 18 wherein the informational data received is generated by a government agency.

20. The computerized system of claim 18 wherein the computerized device is a personal computer.

21. Computer executable program code residing on a computer-readable medium, the program code comprising instructions for causing the computer to:
receive informational data from an information source;
tag the information with an indicator of the information source;
receive one or more charitable transaction risk variables;
associate the informational data from an information source to the charitable transaction risk variables; and
transmit the informational data associated with the charitable transaction risk variables and an indication of the information source to a designated destination.

22. A computer data signal embodied in a digital data stream comprising data relating to risk management, wherein the computer data signal is generated by a method comprising the steps of:
receiving informational data from an information source;
tagging the information with an indicator of the information source;
receiving one or more charitable transaction risk variables;
associating the informational data from an information source to the charitable transaction risk variables; and
transmitting the informational data associated with the charitable transaction risk variables and an indication of the information source to a designated destination.

23. A method of interacting with a network access device so as to manage risk relating to a charitable transaction, the method comprising the steps of:
identifying one or more risk variables;
transmitting the one or more risk variables to a risk management server;
receiving informational data related to at least one of the risk variables;
requesting a link to an information source associated with the informational data received; and
receiving an indication of how to contact the information source.
